(19) United States
(12) Patent Application Publication
(10) Pub. No.: US 2002/0007272 A1
(43) Pub. Date: Jan. 17, 2002

(54) Speech coder and speech decoder

(75) Inventor: Kazunori Ozawa, Tokyo (JP)

Correspondence Address: SUGHRUE, MION, ZINN, MACPEAK & SEAS, 2100 Pennsylvania Avenue, N.W., Washington, DC, 20037-3202, US

(73) Assignee: NEC CORPORATION

(21) Appl. No.: 09/852,274

(22) Filed: May 10, 2001

(30) Foreign Application Priority Data
May 10, 2000 (JP) 137105/2000

(51) Int. Cl. G10L 19/12; G10L 21/00

(52) U.S. Cl. 704/223

(57) ABSTRACT

In order to provide speech coder and speech decoder where excellent sound qualities are obtained even at a low bit rate, a plural position-sets storing circuit 460 holds a plurality of sets for positions of pulses in the speech coder. In addition, an excitation quantization circuit 350 calculates distortions for speech signal by the use of every sets of the positions of pulses, and selects a set of positions with a minimized distortion. The judgement information representative of the selected set is delivered with a small number of bits.

### BACKGROUND OF THE INVENTION

This invention relates to a speech coder for coding a speech signal with a high quality at a low bit rate, a speech decoder, a speech coding method, and a speech decoding method.

As a method for coding a speech signal at a high efficiency, CELP (Code Excited Linear Predictive Coding) is known in the art, and is described, for example, in H. Schroeder and B. Atal, “Code-excited linear prediction: High quality speech at very low bit rates” (Proc. ICASSP, pp. 937-940, 1985: hereinafter referred to as Document 1), Kleijn et al, “Improved speech quality and efficient vector quantization in CELP” (Proc. ICASSP, pp. 155-158, 1988: hereinafter referred to as Document 2), and so on.

In the conventional method, on a transmission side, spectral parameters representative of spectral characteristics of a speech signal are extracted from the speech signal for each frame (e.g. 20 ms long) by the use of a linear predictive (LPC) analysis. Then, each frame is divided into subframes (e.g. 5 ms long). For each subframe, parameters (a gain parameter and a delay parameter corresponding to a pitch period) are extracted from an adaptive codebook on the basis of a preceding excitation signal. By the use of an adaptive codebook, the speech signal of the subframe is pitch-predicted. For an excitation signal obtained by the pitch prediction, an optimum excitation code vector is selected from an excitation codebook (vector quantization codebook) comprising predetermined kinds of noise signals and an optimum gain is calculated. Thus, an excitation signal is quantized.

The excitation code vector is selected so as to minimize error power between a signal synthesized by the selected noise signal and the above-mentioned residual signal.

An index representative of the species of the selected code vector, the gains the spectral parameters, and the parameters of the adaptive codebook are combined together by a multiplexer unit and transmitted.

However, there are two major problems in the above-mentioned conventional method.

A first one of the problems is that a large amount of calculation is required to select the optimum excitation code vector from the excitation codebook.

This is because, in the methods described in Document 1 and Document 2, filtering or a convolution operation should be carried out for each code vector in order to select the excitation code vector. Besides, the operation is repeated multiple times equal in number to code vectors stored in the codebook.

For example, in case where the codebook has B bits and N dimensions, let the filter length or the impulse response length upon the filtering or the convolution operation be represented by K. Then, the amount of calculation of N×K×2⁸×8000/N is required per second.

By way of example, consideration will be made about the case where B=10, N=40, and k=10. In this case, the number of calculations is 81,920,000 times per second and thus a great number of calculations should be carried out.

In order to reduce an amount of calculations required to search the excitation codebook, various methods have been proposed.

For example, an ACELP (Algebraic Code Excited Linear Prediction) method is proposed. This method is described, for example, in C. Laflamme et al. “16 kbps wideband speech coding technique based on algebraic CELP” (Proc. ICASSP, pp. 13-16, 1991: hereinafter referred to as Document 3).

According to the method described in Document 3, an excitation signal is expressed by a plurality of pulses, and furthermore, each of positions of the pulses is represented by a predetermined number of bits and is transmitted. Herein, the amplitude of each pulse is restricted to +1.0 or −1.0. Therefore, the amount of calculations required to search the pulses can considerably be reduced.

A second one of the problems is that excellent sound quality is obtained at a bit rate of 8 kb/s or more but sound quality of a coded speech is seriously deteriorated at a lower bit rate. This is because the number of pulses for a single subframe is not enough to represent the excitation signal, which makes the appropriate representation of a sound source difficult with high accuracy.

### SUMMARY OF THE INVENTION

In the light of the above-mentioned problems arising in the conventional methods, it is an object of this invention to provide a speech coder, a speech decoder, a speech coding method and a speech decoding method, all of which require relatively small amounts of calculation but are suppressed in deterioration of the sound quality even if a bit rate is low.

In order to achieve the above-mentioned object, a speech coder according to a first aspect of the present invention comprises spectral parameter calculating means supplied with a speech signal for calculating spectral parameters, and quantizing the speech signal; impulse response calculating means for converting said spectral parameters into impulse responses; adaptive codebook means for calculating a delay and a gain from a preceding quantized exaltation signal by the use of an adaptive codebook, predicting the speech signal to calculate a residue signal, and outputting said delay and said gain; and excitation quantization means for representing excitation signal of said speech signal by a combination of a plurality of pulses having nonzero amplitudes, and quantizing said excitation signal and said gain by the use of said impulse responses. The excitation quantization means holds a plurality of sets for positions of said pulses, calculates distortion between said speech signal and each of said plurality of sets by the use of said impulse responses, selects a set for positions minimizing said distortion, and outputs judgement codes representative of the selected set, so that the pulse position is quantized.

According to a second aspect of the present invention, it is desirable that the speech coder further comprises multiplexer means for producing a combination of the output of said spectral parameter calculating means, the output of said adaptive codebook means, and the output of said excitation quantization means.

A speech coder according to a third aspect of the present invention comprises spectral parameter calculating means supplied with a speech signal for calculating, quantizing spectral parameters; impulse response calculating means for converting said spectral parameter into impulse responses; adaptive codebook means for calculating a delay and a gain from a preceding quantized excitation signal by the use of an adaptive codebook, predicting the speech signal to calculate a residue signal, and outputting said delay and said gain; and excitation quantization means for representing excitation signal of said speech signal by a combination of a plurality of pulses having nonzero amplitudes, and quantizing and outputting said excitation signal and said gain by the use of said impulse responses. The excitation quantization means holds a plurality of sets for positions of said pulses, calculates distortion between said speech signal and each of said plurality of sets by the use of said impulse responses, selects at least one set for positions minimizing said distortion, reads gain code vectors out of a gain codebook for each of said plurality of sets to quantize a gain, calculates distortion between said speech signal and the gain, selects a combination of said position minimizing said distortion and said gain code vectors, and outputs judgement codes representative of the selected set for positions.

According to a fourth aspect of the present invention, it is desirable that the speech coder further comprises multiplexer means for producing a combination of the output of said spectral parameter calculating means, the output of said adaptive codebook means, and the output of said excitation quantization means.

A speech coder according to a fifth aspect of the present invention comprises spectral parameter calculating means supplied with a speech signal for calculating and quantizing spectral parameters; impulse response calculating means for converting said spectral parameters into impulse responses; adaptive codebook means for calculating a delay and a gain from a preceding quantized excitation signal by the use of an adaptive codebook, predicting the speech signal to calculate a residue signal, and outputting said delay and said gain; and excitation quantization means for representing excitation signal of said speech signal by a combination of a plurality of pulses having nonzero amplitudes, and quantizing and outputting said excitation signal and said gain by the use of said impulse responses. The excitation quantization means comprises mode judging means for judging and outputting a mode by extracting feature quantities from the speech signal; and in the case where the output of said judging means is a predetermined mode. The excitation quantization means holds a plurality of sets for positions of said pulses, calculates distortion between said speech signal and each of said plurality of sets by the use of said impulse responses, selects a set for positions minimizing said distortion, and outputs judgement codes representative of the selected set for positions, so that the pulse position is quantized.

According to a sixth aspect of the present invention, it is desirable that the speech coder further comprises multiplexer means for producing a combination of the output of said spectral parameter calculating means, the output of said adaptive codebook means, the output of said excitation quantization means and the output of said mode judging means.

A speech coder according to a seventh aspect of the present invention comprises plural position-sets storing means for holding a plurality of sets for positions of pulses; and excitation quantization means for calculating distortion between a speech signal and each of said plurality of sets, so as to select a set for positions minimizing said distortion.

A speech decoder according to an eighth aspect of the present invention comprises demultiplexer means supplied with a first code for spectral parameters, a second code for an adaptive codebook, a third code for an excitation signal, a fourth code representative of a selected set for positions, and a fifth code representative of a gain, for demultiplexing them into each code; excitation signal producing means for producing adaptive code vectors by the use of said second code, producing pulses having nonzero amplitudes by the use of said third and said fourth codes, producing an excitation signal by multiplying them by the gain based on said fifth code; and synthesis filter means comprising spectral parameters, said synthesis filter means responsive to said excitation signal, for producing a reproduced signal.

A speech decoder according to a ninth aspect of the present invention comprises demultiplexer means supplied with a first code for spectral parameters, a second code for an adaptive codebook, a third code for an excitation signal, a fourth code representative of a selected set for positions, a fifth code representative of a gain, and a sixth code representative of a mode, for demultiplexing them into each code; excitation signal producing means for producing adaptive code vectors by the use of said second code, and furthermore, in the case where said sixth cods is a predetermined mode, producing pulses having nonzero amplitudes for the selected set for positions by the use of said third and said fourth codes, and producing an excitation signal by multiplying them by the gain based on said fifth code; and synthesis filter means which has spectral parameters and which is responsive to said excitation signal, for producing a reproduced signal.

A speech coding method according to a tenth aspect of the present invention comprising first step of responding to a speech signal to calculate spectral parameters and to quantize the speech signal; second step of converting said spectral parameters into impulse responses; third step of calculating a delay and a gain from a previous quantized excitation signal by the use of an adaptive codebook, predicting the speech signal to calculate a residue signal; and fourth step of representing excitation signal of said speech signal by a combination of a plurality of pulses having nonzero amplitudes, quantizing said excitation signal and said gain by the use of said impulse responses, calculating distortion between said speech signal and each of said plurality of sets for positions of pulses by the use of said impulse responses, selecting a set for positions minimizing said distortion, and outputs judgement codes representative of the selected set, so that the pulse position is quantized.

According to an eleventh aspect of the present invention, it is desirable that the speech coding method further comprises a step of producing a combination of the outputs of said first, said second and said fourth steps.

A speech coding method according to a twelfth aspect of the present invention comprises a first step of responding to a speech signal to calculate and quantize spectral parameters; second step of converting said spectral parameters into impulse responses; third step of calculating a delay and a gain from a preceding quantized excitation signal by the use of an adaptive codebook, and predicting the speech signal to calculate a residue signal; and fourth step of representing excitation signal of said speech signal by a combination of a plurality of pulses having nonzero amplitudes, quantizing said excitation signal and said gain by the use of said impulse responses, calculating distortion between said speech signal and each of said plurality of sets for positions of said pulses by the use of said impulse responses, selecting at least one set for positions minimizing said distortion, reads gain code vectors out of a gain codebook for each of said plurality of sets to quantize a gain, calculating distortion between said speech signal and the gain, selecting a combination of said position minimizing said distortion and said gain code vectors, and outputting judgement codes representative of the selected set for positions.

According to a thirteenth aspect of the present invention, it is desirable that the speech coding method further comprises a step of producing a combination of the outputs of said first, said second and said fourth steps.

A speech coding method according to a fourteenth aspect of the present invention comprises first step of responding to a speech signal to calculate and quantize spectral parameters; second step of converting said spectral parameters into impulse responses; third step of calculating a delay and a gain from a preceding quantized excitation signal by the use of an adaptive codebook, and predicting the speech signal to calculate a residue signal; fourth stop of judging a mode by extracting feature quantities from the speech signal; and fifth step of representing excitation signal of said speech signal by a combination of a plurality of pulses having nonzero amplitudes, quantizing said excitation signal and said gain by the use of said impulse responses, and furthermore, in the case where the output of said fourth step is a predetermined mode, calculating distortion between said speech signal and each of said plurality of sets for positions of pulses by the use of said impulse responses, selecting a position set minimizing said distortion, and outputting judgement codes representative of the selected set for positions, so that the pulse position is quantized.

According to a fifteenth aspect of the present invention, it is desirable that the speech coding method further comprises a step of producing a combination of the outputs of said first, said second, said fourth and said fifth steps.

According to a sixteenth aspect of the present invention, a speech coding method comprises steps of: calculating distortion between a speech signal and each of a plurality of sets for positions of pulses; and selecting a set for positions which minimizes said distortions

A speech decoding method according to a seventeeth aspect of the present invention comprises: first step of responding to a first code for spectral parameters, a second code for an adaptive codebook, a third code for an excitation signal, a fourth code representative of a selected set for positions, and a fifth code representative of a gain, to demultiplex them into each code; second step of producing adaptive code vectors by the use of said second code, producing pulses having nonzero amplitudes by the use of said third and said fourth codes, and producing an excitation signal by multiplying them by the gain based on said fifth code; and third step of, in response to said excitation signal, producing a reproduced signal.

According to an eighteenth aspect of the present invention, a speech decoding method comprises: first step of responding to a first code for spectral parameters, a second code for an adaptive codebook, a third code for an excitation signal, a fourth code representative of a selected set for positions, a fifth code representative of a gain, and a sixth code representative of a mode, demultiplexing them into each code; second step of producing adaptive code vectors by the use of said second code, and furthermore, in the case where said sixth code is a predetermined mode, producing pulses having nonzero amplitudes for the selected set for positions by the use of said third and said fourth codes, and producing an excitation signal by multiplying them by the gain based on said fifth code; and third step of, in response to said excitation signal, producing a reproduced signal.

### BRIEF DESCRIPTION OF THE DRAWING

FIG. 1 is a block diagram showing the speech coder according to a first embodiment of this invention.

FIG. 2 is a block diagram showing the speech coder according to a second embodiment of this invention.

FIG. 3 is a block diagram showing the speech coder according to a third embodiment of this invention.

FIG. 4 is a block diagram showing the speech decoder according to a fourth embodiment of this invention.

FIG. 5 is a block diagram showing the speech decoder according to a fifth embodiment of this invention.

### DESCRIPTION OF THE PREFERRED EMBODIMENTS

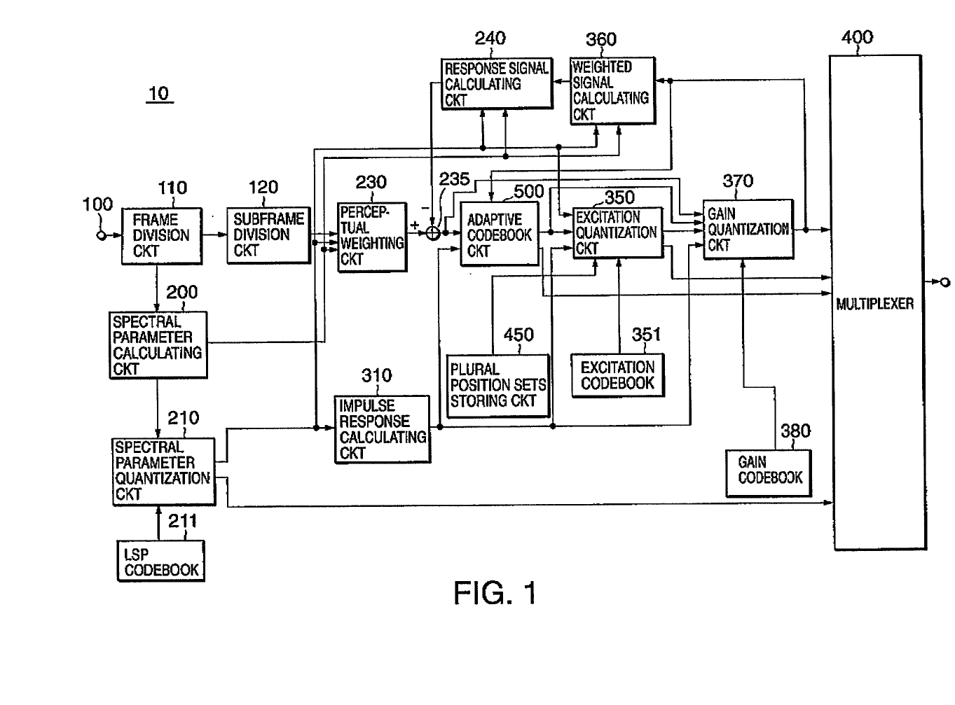

FIG. 1 is a block diagram of a speech coder 10 according to a first mode for embodying this invention. The illustrated speech coder 10 according to the first embodiment comprises an input terminal 100, a frame division circuit 110, a subframe division circuit 120, a spectral parameter calculating circuit 200, a spectral parameter quantization circuit 210, an LSP codebook 211, a perceptual weighting circuit 230, a subtracter 235, a response signal calculating circuit 240, an impulse response calculating circuit 310, an excitation quantization circuit 350, an excitation codebook 351, a weighted signal calculating circuit 360, a gain quantization circuit 370, a gain codebook 380, a multiplexer 400, a plural position-sets storing circuit 450, and an adaptive codebook circuit 500.

Description will be made about operation of the speech coder 10 according to the first embodiment. When receiving a speech signal on the input terminal 100, the speech coder 10 divides the speech signal into frames (e.g. 20 m long) by the use of the frame division circuit 110.

Then, the subframe division circuit 120 further divides the speech signal of each frame into subframes (e.g. 10 ms long) shorter than each of the frames.

The spectral parameter calculating circuit 200 opens a window (e.g. 24 ms long) longer than the subframe length in response to at least one subframe of the speech signal and extracts a speech, thereby calculating spectral parameters with a predetermined degree (e.g. P=10).

For the calculation of the spectral parameters at the spectral parameter calculating circuit 200, the well-known LPC (Linear Predictive Coding) analysis, the Burg analysis, and so forth can be applied. In this embodiment, the Burg analysis is assumed to be adopted. Au regards the details of the Burg analysis, reference will be made to the description in “Signal Analysis and System Identification” written by Nakamizo (published in 1998, Corona), pages 82-87 (hereinafter referred to as Document 4).

In addition, the spectral parameter calculating circuit 200 converts linear prediction coefficients αᵢ (i=1, . . . , 10) calculated by the Burg analysis into LSP parameters suitable for quantization and interpolation on the basis of the LSP codebook 211. For the conversion from the linear prediction coefficients into the LSP parameters, reference may be made to Sugamura et al, “Speech Data Compression by Linear Spectral Pair (LSP) Speech Analysis-Synthesis Technique” (Journal of the Electronic Communications Society of Japan, J64-A, pp. 599-606, 1981: hereinafter referred to as Document 5).

For example, the linear prediction coefficients calculated by the Burg analysis for a second subframe are converted into the LSP parameters, while the LSP parameters of a first subframe are calculated by linear interpolation and are thereafter inversely converted into and returned back to the linear prediction coefficients. Thus, the linear prediction coefficients for the first and the second subframes can be obtained in the form of αᵢₗ (i=1, . . . , 10, l=1,2).

The linear prediction coefficients αᵢₗ (i=1, . . . , 10, 1=1,2) of the first and the second subframes, calculated as mentioned above, are delivered from the spectral parameter calculating circuit 200 to the perceptual weighting circuit 230.

The spectral parameter calculating circuit 200 also delivers the LSP parameters of the second subframe into the spectral parameter quantization circuit 210.

The spectral parameter quantization circuit 210 efficiently quantizes a LSP parameter of a predetermined subframe to produce a quantization value which minimizes the distortion Dⱼ in accordance with the following equation (1).

$${D}_{j} = {\sum }_{i = 1}^{10} {W ( i ) [ LSP ( i ) - {QLSP ( i )}_{j} ]}^{2} \qquad ( 1 )$$

In the equation (1), LSP(i), QLSP(i)ⱼ, W(i) represent an i-th order LSP coefficient before quantization, a j-th result after quantization, and a weighting factor, respectively.

In the following description, vector quantization is used as a quantization method and the LSP parameters of the second subframe are quantized.

For the vector quantization of the LSP parameters, well-known techniques can be applied. For the details of the techniques, reference can be made to the description in Japan Patent Laid-Open No. H04-171500 (hereinafter referred to as Document 6), Japan Patent Laid-Open No. H04- 363000 (hereinafter referred to as Document 7), Japan Patent Laid-Open No. H05-6199 (hereinafter referred to as Document 8), T. Nomura et al, “LSP Coding Using VQ-SVQ With Interpolation in 4.075 kbps M-LCELP Speech Coder” (Proc. Mobile Multimedia Communications, pp. B.2.5, 1993: hereinafter referred to as Document 9), and so forth. Hence, explanation of the details of the techniques is omitted herein.

On the basis of the LSP parameters quantized for the second subframe, the spectral parameter quantization circuit 210 restores or reproduces the LSP parameters; of the first and the second subframes. More specifically, the spectral parameter quantization circuit 210 carries out the linear interpolation between the quantized LSP parameters of the second subframe of a current frame and the quantized LSP parameters of the second subframe of a previous frame immediately before the current frame. As the result of the linear interpolation, the LSP parameters of the first and the second subframes can be reproduced. Then, the spectral parameter quantization circuit 210 selects one kind of the code vectors which minimizes the error power between the LSP parameters before quantization and the LSP parameters after quantization. Thereafter, the spectral parameter quantization circuit 210 reproduces the LSP parameters of the first and the second subframes by carrying out the linear interpolation.

In order to further improve the performance, the spectral parameter quantization circuit 210 may select a plurality of candidate code vectors which minimize the error power, evaluate cumulative distortion for each of the candidates, and select a combination of the candidate and the interpolated LSP parameter, the selected combination minimizing the cumulative distortion. For example, the details of the related technique are disclosed in Japan Patent No. 2746039 (Japan Patent Laid-Open No. H06-222797: hereinafter referred to as Document 10).

The spectral parameter quantization circuit 210 converts the LSP parameters of the first and the second subframes reproduced in the manner mentioned above and the quantized LSP parameters of the second subframe into the linear prediction coefficients α*ᵢₗ (i=1, . . . , 10, l=1,2) for each subframe, and outputs the linear prediction coefficients α*il into the impulse response calculating circuit 310.

Also, the spectral parameter quantization circuit 210 supplies the multiplexer 400 with an index indicating the code vector of the quantized LSP parameters of the second subframe.

Supplied from the spectral parameter calculating circuit 200 with the linear prediction coefficients αᵢₗ (i=1, . . . , 10, l=1,2) before quantization for each subframe, the perceptual weighting circuit 230 carries out the perceptual weighting, in a manner mentioned in Document 1, for the speech signal of the subframe and produces a perceptual weighted signal.

As shown in FIG. 1, the response signal calculating circuit 240 is supplied from the spectral parameter calculating circuit 200 with the linear prediction coefficients αᵢₗ for each subframe and is also supplied from the spectral parameter quantization circuit 210 with the restored or reproduced linear prediction coefficients αᵢₗ obtained by quantization and interpolation for each subframe. In this situation, the response signal calculating circuit 240 calculates a response signal for one subframe with an input signal assumed to be zero, namely d(n)=0, by the use of a value of a filter memory being reserved, and delivers the response signal to the subtracter 235. Herein, the response signal x_{z}(n) is expressed by the following equations (2) through (4).

$$\begin{matrix}{x}_{z} ( n ) = d ( n ) - {\sum }_{i = 1}^{10} {α}_{i} d ( n - i ) + {\sum }_{i = 1}^{10} {α}_{i} {γ}^{i} y ( n - i ) + \\ {\sum }_{i = 1}^{10} {α}_{l}^{′} {γ}^{l} {x}_{x} ( n - i )\end{matrix} \qquad ( 2 )$$

If n−i≦0:

y(n−i)=p(N+(n−i)) (3)

x_{z}(n−i)=sₓ(N+(n−i)) (4)

In the equations (2) through (4), N represents the subframe length. γ represents a weighting factor for controlling a perceptual weight and equal to the value in the equation (7) which will be given below. s_{w}(n) and p(n) represent an output signal of a weighted signal calculating circuit and an output signal corresponding to a denominator of a filter in a first term of the right side in the equation (7) which will later be described, respectively.

The subtracter 235 subtracts the response signal for one subframe from the perceptual weighted signal delivered from the perceptual weighting circuit 230, calculates x′ₓ(n) in accordance with the following equation (5), and delivers the calculated x′_{w}(n) to the adaptive codebook circuit 500.

x′_{w}(n)=x_{w}(n)−xₓ(n) (5)

The impulse response calculating circuit 310 calculates a predetermined number L of impulse responses H_{w}(n) of a perceptual weighting filter whose z transform is expressed by the following equation (6), and delivers the calculated impulse responses H_{w}(n) to the adaptive codebook circuit 500, the excitation quantization circuit 350 and the gain quantization circuit 370.

$${H}_{w} ( Z ) = \frac{1 - {\sum }_{i = 1}^{10} {α}_{i} {z}^{- 1}}{1 - {\sum }_{i = 1}^{10} {α}_{i} {γ}^{i} {z}^{- 1} 1 - {\sum }_{i = 1}^{10} {α}_{i}^{′} {γ}^{i} {z}^{- i}} \qquad ( 6 )$$

The adaptive codebook circuit 500 is supplied with a preceding excitation signal v(n) from the gain quantization circuit 365, the output signal x′_{w}(n) from the subtracter 235, and the perceptual weighted impulse response H_{w}(n) from the impulse response calculating circuit 310. The adaptive codebook circuit 500 calculates a delay T corresponding to a pitch such that distortions in the following equations (7) and (8) are minimized, and delivers an index representative of the delay T to the multiplexer 400.

$${D}_{T} = {\sum }_{n = 0}^{N - 1} {x}_{w}^{′2} ( n ) - {[ {\sum }_{n =}^{N - 1} {x}_{w}^{′} ( n ) {y}_{w} ( n - T ) ]}^{2} / [ {\sum }_{n =}^{N - 1} {y}_{w}^{2} ( n - T ) ] \qquad ( 7 )$$

y_{w}(n−T)=v(n−T)*h_{w}(n) (8)

In the equation (8), the symbol * represents a convolution operation.

A gain β is calculated in accordance with the following equation (9).

$$β = {\sum }_{n = 0}^{N - 1} {x}_{w}^{′} ( n ) {y}_{w} ( n - T ) / {\sum }_{n = 0}^{N - 1} {y}_{w}^{2} ( n - T ) \qquad ( 9 )$$

Herein, in order to improve the accuracy in extracting the delay with respect to a female sound or a child voice, the delay may be obtained from a sample value having floating point, instead of a sample value consisting of integral numbers. The details of the technique are disclosed, for example, in P. Kroon et al, “Pitch predictors with high temporal resolution” (Proc. ICASSP, pp. 661-664, 1990: hereinafter referred to as Document 11) and so on.

Furthermore, the adaptive codebook circuit 500 carries out pitch prediction in accordance with the following equation (10) and delivers a prediction residual signal e_{w}(n) to the excitation quantization circuit 350.

e_{w}(n)=x′_{w}(n)−βv(n−T)*h_{w}(n) (10)

The excitation quantization circuit 350 produces the excitation signal for subframes represented by M pulses.

In the illustrated example, the plural position-sets storing circuit 450 stores a plurality of sets of positions in advance. For example, it is assumed that M is equal to four in the following. In this event, four sets of positions are stored, which are shown in the Tables 1 through 4, respectively. Herein, it is noted that a first pulse in Tables 1 through 4 is generated at either one of four candidate positions 0, 20, 40, and 60 while the remaining pulses are generated at candidate positions shown in Tables 1 through 4.

(Table 1 first set of positions)

| Pulse Number | set of positions |
|---|---|
| first pulse | 0, 20, 40, 60 |
| second pulse | 1, 21, 41, 61 |
| third pulse | 2, 22, 42, 62 |
| | 3, 23, 43, 63 |
| fourth pulse | 4, 24, 44, 64 |
| | 5, 25, 45, 65 |
| | 6, 26, 46, 66 |
| | 7, 27, 47, 67 |
| | 8, 28, 48, 68 |
| | 9, 29, 49, 69 |
| | 10, 30, 50, 70 |
| | 11, 31, 51, 71 |
| | . . . |
| | 19, 39, 59, 79 |

(Table 2 second set of positions)

| Pulse Number | set of positions |
|---|---|
| first pulse | 0, 20, 40, 60 |
| second pulse | 1, 21, 41, 61 |
| third pulse | 2, 22, 42, 62 |
| | 3, 23, 43, 63 |
| | . . . |
| | 17, 37, 57, 77 |
| fourth pulse | 18, 38, 58, 78 |
| | 19, 39, 59, 79 |

TABLE 3
(third set of positions)

| Pulse Number | set of positions |
|---|---|
| first pulse | 0, 20, 40, 60 |
| second pulse | 1, 21, 41, 61 |
| | 2, 22, 42, 62 |
| | 3, 23, 43, 63 |
| | 4, 24, 44, 64 |
| | . . . |
| | 16, 36, 56, 76 |
| third pulse | 17, 37, 57, 77 |
| | 18, 38, 58, 78 |
| fourth pulse | 19, 39, 59, 79 |

TABLE 4
(fourth set of positions)

| Pulse Number | set of positions |
|---|---|
| first pulse | 0, 20, 40, 60 |
| | 1, 21, 41, 61 |
| | . . . |
| | 15, 35, 55, 75 |
| second pulse | 16, 36, 56, 76 |
| | 17, 37, 57, 77 |
| third pulse | 18, 38, 58, 78 |
| fourth pulse | 19, 39, 59, 79 |

In order to collectively quantize pulse amplitudes for the M pulses, the speech coder 10 further comprises a polarity codebook or an amplitude codebook of B bits. In the following, description will be made about the case where the polarity codebook is used. The polarity codebook is stored in the excitation codebook 351.

The excitation quantization circuit 350 reads polarity code vectors out of the excitation codebook 351, assigns each code vector with each position of the foregoing first through fourth sets of positions, and selects a combination of the code vector and the set of positions such that the combination minimizes the following equation (11).

$${D}_{k} = {\sum }_{n = 0}^{N - 1} {[ {e}_{w} ( n ) - {\sum }_{i = 1}^{M} {g}_{ik}^{′} {h}_{w} ( n - {m}_{i} ) ]}^{2} \qquad ( 11 )$$

In the equation (11) h_{w}(n) is a perceptual weighted impulse response.

In order to minimize the equation (11), the calculation may be carried out for finding a combination of a polarity code vector gᵢₖ and a position mᵢ, the combination maximizing the following equation (12).

$$D ( k , i ) = {[ {\sum }_{n = 0}^{N - 1} {e}_{w} ( n ) {s}_{wk} ( {m}_{i} ) ]}^{2} / {\sum }_{n = 0}^{N - 1} {s}_{wk}^{2} ( {m}_{i} ) \qquad ( 12 )$$

Alternatively, the combination of the polarity code vector gᵢₖ and the position mᵢ may be selected so that the following equation (13) is maximized. As the equation (13) is used, the amount of calculation of a numerator is decreased.

$$\begin{matrix}D ( k , i ) = {[ {\sum }_{n = 0}^{N - 1} φ ( n ) vk ( n ) ]}^{2} / {\sum }_{n = 0}^{N - 1} {s}_{wk}^{2} ( m i ) \\ where & ( 13 ) \\ φ ( n ) = {\sum }_{i = n}^{N - 1} {e}_{w} ( i ) {h}_{w} ( i - n ) , \\ n = 0 , … , N - 1 & ( 14 )\end{matrix}$$

After searching the polarity code vector gᵢₖ, the excitation quantization circuit 350 supplies the gain quantization circuit 370 with the selected combination of the polarity code vector gᵢₖ and the set of positions.

Supplied with the combination of the polarity code vector gᵢₖ and the position set from the excitation quantization circuit 350, the gain quantization circuit 370 reads gain code vectors out of the gain codebook 380 and selects the gain code vector such that the following equation (15) is minimized.

$${D}_{k} = {\sum }_{n = 0}^{N - 1} {[ {x}_{w} ( n ) - {β}_{i}^{′} v ( n - T ) * {h}_{w} ( n ) - {G}_{i}^{′} {\sum }_{i = 1}^{M} {g}_{ik}^{′} {h}_{w} ( n - {m}_{i} ) ]}^{2} \qquad ( 15 )$$

The above description was made about the case where the gain quantization circuit 365 carries out vector quantization simultaneously upon both of a gain of the adaptive codebook and a gain of an excitation expressed by pulses. The gain quantization circuit 370 delivers, to the multiplexer 400, the index indicative of the selected polarity code vector, the codes representative of the position, and the index indicative of the gain code vector.

The codebook may be preliminarily obtained and stored by learning from the speech signal. The learning method of the codebook is disclosed, for example, in Linde et al. “An algorithm for vector quantization design” (IEEE Trans. Commun., pp. 84-95, January, 1980: hereinafter referred to as Document 12).

The weighted signal calculating circuit 360 is supplied with the indexes and reads the code vector corresponding to each index. Then, the weighted signal calculating circuit 360 calculates a drive excitation signal v(n) in accordance with the following equation (16).

$$v ( n ) = {β}_{i}^{′} v ( n - T ) + {G}^{′} {\sum }_{i = 1}^{M} {g}_{ik}^{′} δ ( n - {m}_{i} ) \qquad ( 16 )$$

The drive excitation signal v(n) is delivered from the weighted signal calculating circuit 360 to the multiplexer 400 and the adaptive codebook circuit 600.

Next, by the use of the output parameter of the spectral parameter calculating circuit 200 and the output parameter of the spectral parameter quantization circuit 210, the weighted signal calculating circuit 360 calculates the response signal s_{w}(n) for each subframe in accordance with the following equation (17), and delivers the response signal s_{w}(n) to the response signal calculating circuit 240.

$$\begin{matrix}{s}_{w} ( n ) = v ( n ) - {\sum }_{i = 1}^{10} {a}_{i } v ( n - i ) + {\sum }_{i = 1}^{10} {a}_{i} {γ}^{i} p ( n - i ) + \\ {\sum }_{i = 1}^{10} {a}_{i}^{′} {γ}^{i} {s}_{w} ( n - i )\end{matrix} \qquad ( 17 )$$

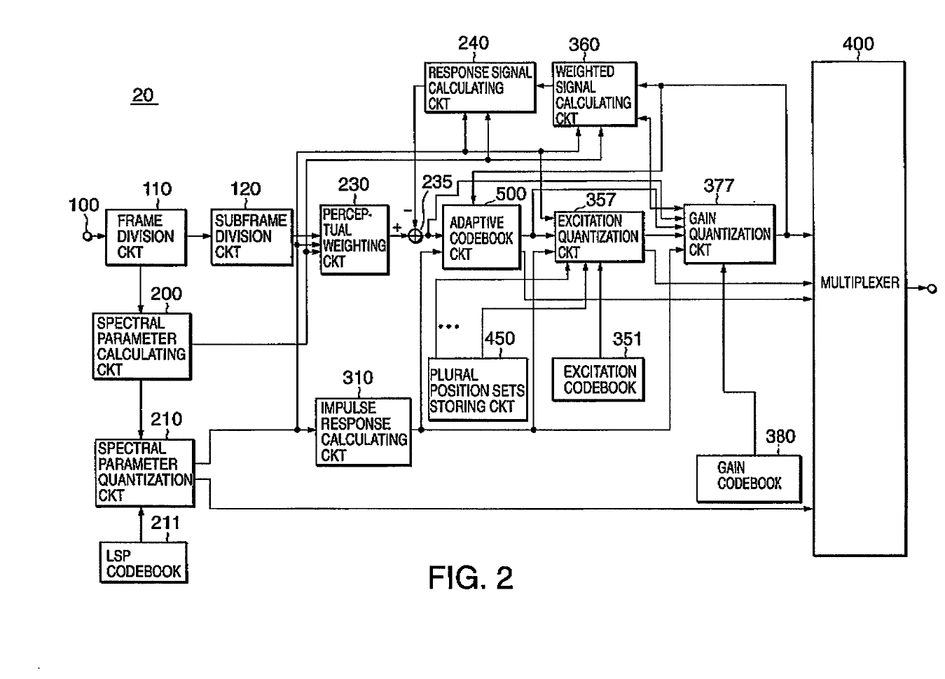

FIG. 2 is a block diagram of a speech coder 20 according to a second embodiment of this invention. The common numerical references are labeled in the speech coder 20 of the second embodiment shown in FIG. 2 to the components which correspond to those in the speech coder 10 of the first embodiment shown in FIG. 1. In this connection, it is readily understood that the respective components in the speech coders 10 and 20 are operable in the same manner.

With respect to the following points, operations of the speech coder 20 according to the second embodiment shown in FIG. 2 differ from those of the speech coder 10 according to the first embodiment shown in FIG. 1.

The excitation quantization circuit 357 reads polarity code vectors out of the excitation codebook 351, assigns each code vector with each position of the foregoing first through fourth sets of positions, and selects a plurality of combinations of the code vectors and the sets of positions, the combinations minimizing the equation (11). These combinations are delivered from the excitation quantization circuit 357 to the gain quantization circuit 377.

Supplied with the plural combinations of the polarity code vectors and the sets of positions from the excitation quantization circuit 357, the gain quantization circuit 377 reads gain code vectors out of the gain codebook 380 and selects one of the combinations such that the equation (15) is minimized.

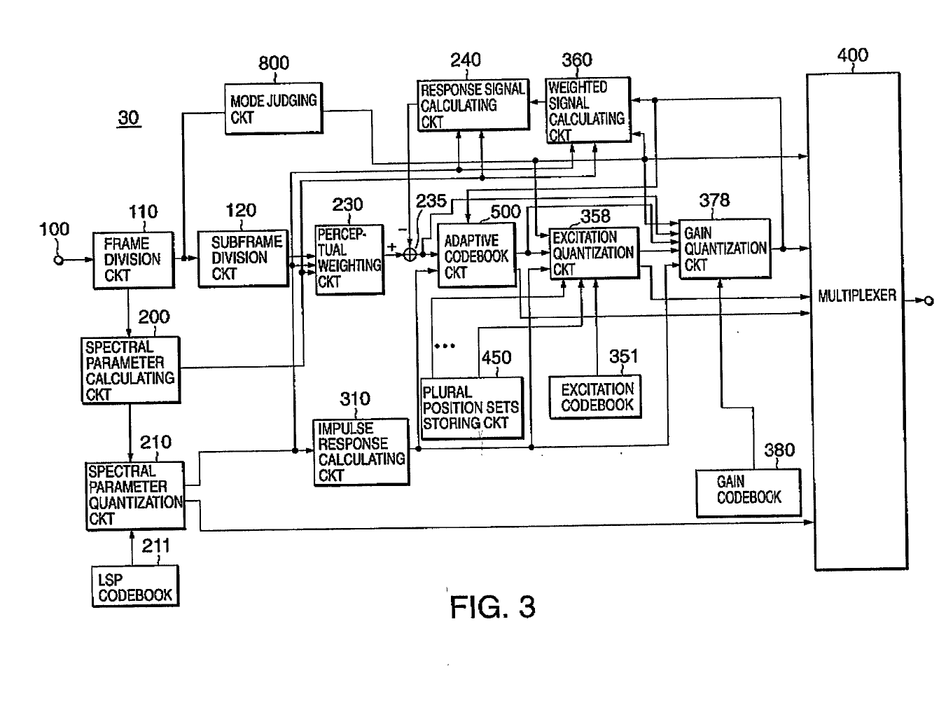

FIG. 3 is a block diagram of a speech coder 30 according to a third embodiment of this invention. The common numerical references are labeled to those components in the speech coder 30 of the third embodiment shown in FIG. 3, which correspond to the components in the speech coder 10 of the first embodiment shown in FIG. 1. In this connection, the respective components in the speech coders 10 and 30 function in the same manner.

Thus, the speech coder 30 according to this embodiment comprises components similar to those of the speech coder 10 according to the first embodiment and further comprises a mode judging circuit 800 for judging a mode for each frame.

With respect to the following points, operations of the speech coder 30 according to the third embodiment shown in FIG. 3 differ from those of the speech coder 10 according to the first embodiment shown in FIG. 1.

The mode judging circuit 800 extracts feature quantities from the output signals of the frame division circuit 110, and judges a mode for each frame. Herein, as the feature quantities, pitch prediction gains may be used. The mode judging circuit 800 averages the pitch prediction gains calculated for every subframes over their frame, compares the average value with a plurality of predetermined threshold values, and categorizes the frame into a plurality of predetermined modes.

As an example, in the case where the number of types of modes is set to 2, the types of modes are mode 0 and mode 1, which correspond to a utterance period and a silence period, respectively.

The mode judging circuit 800 delivers mode judgement information to the excitation quantization circuit 358, the gain quantization circuit 378, and the multiplexer 400, the mode judgement information representing a type of mode.

The excitation quantization circuit 358 is supplied with the mode judgement information from the mode judging circuit 800. If the mode represented by the mode judgement information is mode 1, the excitation quantization circuit 358 refers to the polarity codebook for the plural sets of positions, selects a set of positions and a code vector which make the equation (11) be minimized, and outputs the selected set of positions and the selected code vector. If the mode represented by the mode judgement information is mode 0, the excitation quantization circuit 358 refers to the polarity codebook for a pulse set, which is preliminarily selected to be for example any one of sets shown in the Tables 1 through 4, and selects and outputs a set of positions and a code vector which make the equation (11) be minimized.

Supplied with the mode judgement information from the mode judging circuit 800, the gain quantization circuit 378 reads gain code vectors out of the gain codebook 380, searches, with respect to the selected combination of the polarity code vector and the position, the gain code vector which makes the equation (15) be minimized, and selects a combination of the gain code vector, the polarity code vector and the position, the newly selected combination making the distortion be minimized.

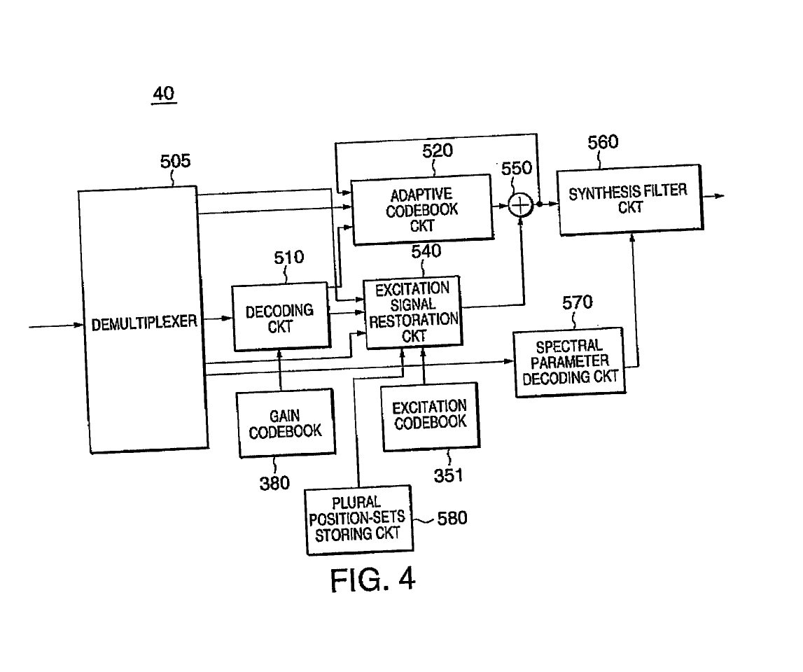

FIG. 4 is a block diagram of a speech decoder 40 according to a fourth embodiment of this invention. The speech decoder 40 according to this embodiment comprises a demultiplexer 505, a gain codebook 380, a decoding circuit 510, an adaptive codebook circuit 520, an excitation signal restoration ro reproduction circuit 540, an excitation codebook 351, an adder 550, a synthesis filter circuit 560, a spectral parameter decoding circuit 570, a plural position-sets storing circuit 580.

The speech decoder 40 according to the fourth embodiment is operable in the following manner. The demultiplexer 505 demultiplexes a code sequence into a position-set judgement information, an index indicative of a gain code vector, an index indicative of a delay on the adaptive codebook, information of the excitation signal, an index indicative of the excitation code vector, an index indicative of a spectral parameter.

The gain decoding circuit 510 is supplied from the demultiplexer with the index indicative of the gain code vector, reads a gain code vector out of the gain codebook 380 in accordance with the index, and outputs the gain code vector.

The adaptive codebook circuit 520 is supplied from the demultiplexer 505 with the delay of the adaptive codebook, produces an adaptive code vector, multiplies the adaptive code vector by the gain of the adaptive codebook based on the gain code vector, and outputs the adaptive code rector.

The excitation signal restoration circuit 540 is supplied from the demultiplexer 505 with the position-set judgment information, and reads, out of the plural position-sets storing circuit 580, a position set selected on the basis of the position-set judgement information.

Furthermore, the excitation signal restoration circuit 540 produces an excitation pulse by the use of the polarity code vector and the gain code vector both read out of the excitation codebook 351, and delivers the excitation pulse to the adder 550.

The adder 550 calculates a drive excitation signal v(n) from the output of the adaptive codebook circuit 520 and the output of the excitation signal restoration circuit 540, according to the equation (17), and delivers the drive excitation signal v(n) to the adaptive codebook circuit 520 and the synthesis filter circuit 560.

The spectral parameter decoding circuit 570 decodes the spectral parameters, converts the spectral parameters into linear prediction coefficients, and delivers the linear prediction coefficients to the synthesis filter circuit 560.

The synthesis filter circuit 560 is supplied with the drive excitation signal v(n) and the linear prediction coefficients from the adder 550 and the spectral parameter decoding circuit 570, respectively, and calculates and outputs a reproduced signal.

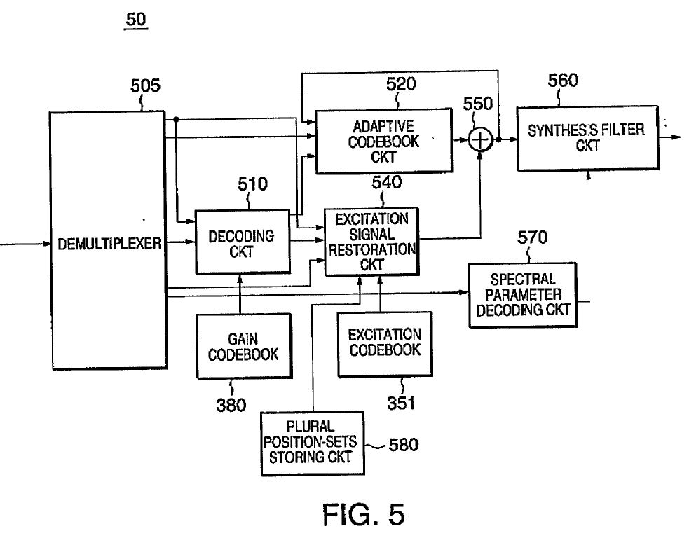

FIG. 5 is a block diagram of a speech decoder 50 according to a fifth embodiment of this invention. The common numerical references are labeled to the components in the speech decoder 50 of the fifth embodiment shown in FIG. 5 and the components in the speech decoder 40 of the fourth embodiment shown in FIG. 4, in the case where the respective components in the speech decoders 40 and 50 function in the same manner.

With respect to the following points, operations of the speech decoder 50 according to the fifth embodiment shown in FIG. 5 differ from those of the speech decoder 40 according to the fourth embodiment shown in FIG. 4.

An excitation signal restoration circuit 590 of the speech decoder 50 according to this embodiment is supplied with the mode judgement information and the position-set judgment information. If the mode represented by the mode judgement information is mode 1, the excitation signal restoration circuit 590 reads, out of the plural position-sets storing circuit 580, a set of positions which is selected on the basis of the position-set judgement information. Also, the excitation signal restoration circuit 590 produces an excitation pulse by the use of the polarity code vector and the gain code vector both read out of the excitation codebook 351, and delivers the excitation pulse to the adder 550. On the other hand, if the mode represented by the mode judgement information is mode 0, the excitation signal restoration circuit 590 produces an excitation pulse by the use of the predetermined pulse of the set of positions and the gain code vector, and delivers the excitation pulse to the adder 550.

Although the above-mentioned first through fifth embodiments provide the examples of the speech coders and the speech decoders, those skilled in the art can readily understand every steps of speech coding methods and speech decoding methods according to the present invention, on the basis of the descriptions for the apparatuses.

As described above, according to this invention, a speech coding system holds a plurality of position sets of pulses. The speech coding system selects a set of positions which minimize the distortion between them and a speech signal, and delivers judgement information representative of the selected set with a small number of bits. Thus, the present invention can provides the speech coding system where the degree of freedom for the pulse position information is high in comparison with the conventional system, and especially, where the sound quality is improved in comparison with the conventional system even if the bit rate is low.

According to this invention, a speech coding system selects at least one set of positions which minimize the distortion between a speech signal and them. For each position set, the speech coding system searches gain code vectors stored in a gain codebook so as to calculate a distortion between them and a speech signal as the primary reproduced signal. Then, the speech coding system selects a combination of the set of positions and the gain code vector so as to minimize the distortion between the combination and a speech signal. Hence, the present invention can provides the speech coding system where the distortion is minimized on the primary reproduced speech signal including a gain code vector and the sound quality is improved.

According to the speech coding system of this invention, a speech decoding system receives judgement codes, and selects, from a plurality of sets of positions, a set of positions which is selected on transmission side. Then the speech decoding system generates pulses with the selected set of positions, multiplies the generated pulses by a gain, and filters them at the synthesis filter circuit so as to reproduce a speech signal. Therefore, the present invention can provides the speech decoding system where the sound quality is improved in comparison with the conventional system, even if the bit rate is low.

What is claimed is:

1. A speech coder comprising:
spectral parameter calculating means supplied with a speech signal for calculating spectral parameters and quantizing the speech signal;
impulse response calculating means for converting said spectral parameters into impulse responses;
adaptive codebook means for calculating a delay and a gain from a previous quantized excitation signal by the use of an adaptive codebook, predicting the speech signal to calculate a residue signal, and outputting said delay and said gain; and
excitation quantization means for representing an excitation signal of said speech signal by a combination of a plurality of pulses having nonzero amplitudes, and quantizing said excitation signal and said gain by the use of said impulse responses; wherein
said excitation quantization means holds a plurality of sets for positions of said pulses, calculates distortion between said speech signal and each of said plurality of sets by the use of said impulse responses, selects a set for positions minimizing said distortion, and outputs judgement codes representative of the selected set, so that the pulse position is quantized.

2. A speech coder as claimed in claim 1, further comprising:
multiplexer means for producing a combination of the output of said spectral parameter calculating means, the output of said adaptive codebook means, and the output of said excitation quantization means.

3. A speech coder comprising:
spectral parameter calculating means supplied with a speech signal for calculating, quantizing and outputting spectral parameters;
impulse response calculating means for converting said spectral parameters into impulse responses;
adaptive codebook means for calculating a delay and a gain from a preceding quantized excitation signal by the use of an adaptive codebook, predicting the speech signal to calculate a residue signal, and outputting said delay and said gain; and
excitation quantization means for representing excitation signal of said speech signal by a combination of a plurality of pulses having nonzero amplitudes, and quantizing and outputting said excitation signal and said gain by the use of said impulse responses; wherein
said excitation quantization means holds a plurality of sets for positions of said pulses, calculates distortion between said speech signal and each of said plurality of sets by the use of said impulse responses, selects at least one set for positions minimizing said distortion, reads gain code vectors out of a gain codebook for each of said plurality of sets to quantize a gain, calculates distortion between said speech signal and the gain, selects a combination of said position minimizing said distortion and said gain code vectors, and outputs judgement codes representative of the selected set for positions.

4. A speech coder as claimed in claim 3, further comprising:
multiplexer means for producing a combination of the output of said spectral parameter calculating means, the output of said adaptive codebook means, and the output of said excitation quantization means.

5. A speech coder comprising:
spectral parameter calculating means supplied with a speech signal for calculating, quantizing and outputting spectral parameters;
impulse response calculating means for converting said spectral parameters into impulse responses;
adaptive codebook means for calculating a delay and a gain from a preceding quantized excitation signal by the use of an adaptive codebook, predicting the speech signal to calculate a residue signal, and outputting said delay and said gain; and
excitation quantization means for representing excitation signal of said speech signal by a combination of a plurality of pulses having nonzero amplitudes, and quantizing and outputting said excitation signal and said gain by the use of said impulse responses; wherein
said excitation quantization means comprises mode judging means for judging and outputting a mode by extracting feature quantities from the speech signal; and
in the case where the output of said judging means is a predetermined mode, said excitation quantization means holds a plurality of sets for positions of said pulses, calculates distortion between said speech signal and each of said plurality of sets by the use of said impulse responses, selects a set for positions minimizing said distortion, and outputs judgement codes representative of the selected set for positions, so that the pulse position is quantized.

6. A speech coder as claimed in claim 5, further comprising:
multiplexer means for producing a combination of the output of said spectral parameter calculating means, the output of said adaptive codebook means, the output of said excitation quantization means and the output of said mode judging means.

7. A speech coder comprising:
plural position-sets storing means for holding a plurality of sets for positions of pulses; and
excitation quantization means for calculating distortion between a speech signal and each of said plurality of sets, so as to select a set for positions minimizing said distortion.

8. A speech decoder comprising:
demultiplexer means supplied with a first code for spectral parameters, a second code for an adaptive codebook, a third code for an excitation signal, a fourth code representative of a selected set for positions, and a fifth code representative of a gain, for demultiplexing them into each code;
excitation signal producing means for producing adaptive code vectors by the use of said second code, pulses of nonzero amplitudes by the use of said third and said fourth codes, and an excitation signal by multiplying them by the gain based on said fifth code; and
synthesis filter means which has spectral parameters and which is responsive to said excitation signal, for producing a reproduced signal.

9. A speech decoder comprising:
demultiplexer means supplied with a first code for spectral parameters, a second code for an adaptive codebook, a third code for an excitation signal, a fourth code representative of a selected set for positions, a fifth code representative of a gain, and a sixth code representative of a mode, for demultiplexing them into each code;
excitation signal producing means for producing adaptive code vectors by the use of said second code, and furthermore, in the case where said sixth code is a predetermined mode, producing pulses having nonzero amplitudes for the selected set for positions by the use of said third and said fourth codes, and producing an excitation signal by multiplying them by the gain based on said fifth code; and
synthesis filter means comprising spectral parameters, said synthesis filter means responsive to said excitation signal, for producing a reproduced signal.

10. A speech coding method comprising:
first step of responding to a speech signal to calculate spectral parameters, and to quantize said speech signal;
second step of converting said spectral parameters into impulse responses;
third step of calculating a delay and a gain from a preceding quantized excitation signal by the use of an adaptive codebook, predicting the speech signal to calculate a residue signal; and
fourth step of representing excitation signal of said speech signal by a combination of a plurality of pulses having nonzero amplitudes, quantizing said excitation signal and said gain by the use of said impulse responses, calculating distortion between said speech signal and each of said plurality of sets for positions of pulses by the use of said impulse responses, selecting a set for positions minimizing said distortion, and outputs judgement codes representative of the selected set, so that the pulse position is quantized.

11. A speech coding method as claimed in claim 10, further comprising a step of producing a combination of the outputs of said first, said second and said fourth steps.

12. A speech coding method comprising:
first step of responding to a speech signal to calculate and quantize spectral parameters;
second step of converting said spectral parameters into impulse responses;
third step of calculating a delay and a gain from a preceding quantized excitation signal by the use of an adaptive codebook, and predicting the speech signal to calculate a residue signal; and
fourth step of representing excitation signal of said speech signal by a combination of a plurality of pulses having nonzero amplitudes, quantizing said excitation signal and said gain by the use of said impulse responses, calculating distortion between said speech signal and each of said plurality of sets for positions of said pulses by the use of said impulse responses, selecting at least one set for positions minimizing said distortion, reads gain code vectors out of a gain codebook for each of said plurality of sets to quantize a gain, calculating distortion between said speech signal and the gain, selecting a combination of said position minimizing said distortion and said gain code vectors, and outputting judgement codes representative of the selected set for positions.

13. A speech coding method as claimed in claim 12, further comprising a step of producing a combination of the outputs of said first, said second and said fourth steps.

14. A speech coding method comprising:
first step of responding to a speech signal to calculate and quantize spectral parameters;
second step of converting said spectral parameters into impulse responses;
third step of calculating a delay and a gain from a preceding quantized excitation signal by the use of an adaptive codebook, and predicting the speech signal to calculate a residue signal;
fourth step of judging a mode by extracting feature quantities from the speech signal; and
fifth step of representing excitation signal of said speech signal by a combination of a plurality of pulses having nonzero amplitudes, quantizing said excitation signal and said gain by the use of said impulse responses, and furthermore, in the case where the output of said fourth step is a predetermined mode, calculating distortion between said speech signal and each of said plurality of sets for positions of pulses by the use of said impulse responses, selecting a position set minimizing said distortion, and outputting judgement codes representative of the selected set for positions, so that the pulse position is quantized.

15. A speech coding method as claimed in claim 14, further comprising a step of producing a combination of the outputs of said first, said second, said fourth and said fifth steps.

16. A speech coding method comprising steps of:
calculating distortion between a speech signal and each of a plurality of sets for positions of pulses; and
selecting a set for positions which minimizes said distortion.

17. A speech decoding method comprising:
first step of responding to a first code for spectral parameters, a second code for an adaptive codebook, a third code for an excitation signal, a fourth code representative of a selected set for positions, and a fifth code representative of a gain, to demultiplex them into each code;
second step of producing adaptive code vectors by the use of said second code, producing pulses having nonzero amplitudes by the use of said third and said fourth codes, and producing an excitation signal by multiplying them by the gain based on said fifth code; and
third step of responding to said excitation signal to produce a reproduced signal.

18. A speech decoding method comprising:
first step of responding to a first code for spectral parameters, a second code for an adaptive codebook, a third code for an excitation signal, a fourth code representative of a selected set for positions, a fifth code representative of a gain, and a sixth code representative of a mode, to demultiplex them into each code;
second step of producing adaptive code vectors by the use of said second code, and furthermore, in the case where said sixth code is a predetermined mode, producing pulses having nonzero amplitudes for the selected set for positions by the use of said third and said fourth codes, and producing an excitation signal by multiplying them by the gain based on said fifth code; and
third step of, in response to said excitation signal, producing a reproduced signal.
